(19) United States
(12) Patent Application Publication
(10) Pub. No.: US 2018/0188923 A1
(43) Pub. Date: Jul. 5, 2018

(54) ARBITRARY CONTROL MAPPING OF INPUT DEVICE

(71) Applicant: CIRQUE CORPORATION, Salt Lake City, UT (US)

(72) Inventor: Paul Vincent, Kaysville, UT (US)

(21) Appl. No.: 15/860,582

(22) Filed: Jan. 2, 2018

Related U.S. Application Data
(60) Provisional application No. 62/440,584, filed on Dec. 30, 2016.

(51) Int. Cl. G06F 3/0481; G06F 3/044; G06F 3/0488; G06F 3/0346; G06F 3/01

(52) U.S. Cl. CPC G06F 3/04815; G06F 3/044; G06F 2203/04101; G06F 3/0346; G06F 3/016; G06F 3/0488

(57) ABSTRACT

A system and method for enabling arbitrary mapping of any number, shape and size of controls or features of a physical input device to a virtual reality device that is used in a virtual reality or augmented reality environment.

### BACKGROUND OF THE INVENTION

### Field of the Invention

This invention relates generally to touch and proximity sensors. More specifically, the invention relates to arbitrary mapping of any number, shape and size of controls or features of a physical input device to a virtual reality device that is used in a virtual reality or augmented reality environment.

### Description of Related Art

There are several designs for capacitive touch sensors which may be used in the present invention. It is useful to examine the underlying technology of the touch sensors to better understand how any capacitance sensitive touch sensor can be modified to operate as an input device in the embodiments of the invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

Input devices are becoming important in virtual reality (VR) of augmented reality (AR) environments because new functions and features may be possible because of the nature of the VR and AR environments. However, it may be difficult to bridge the gap between virtual reality devices and the physical environment. Accordingly, it would be an advantage over the prior art to provide a system and method for making an input device in the physical environment that has a virtual reality counterpart in order to bridge a sensory gap between physical devices and virtual reality device.

### BRIEF SUMMARY OF THE INVENTION

In a first embodiment, the present invention is a system and method for enabling arbitrary mapping of any number, shape and size of controls or features of a physical input device to a virtual reality device that is used in a virtual reality or augmented reality environment.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a touchpad that is found in the prior art, and which is adaptable for use in the present invention.

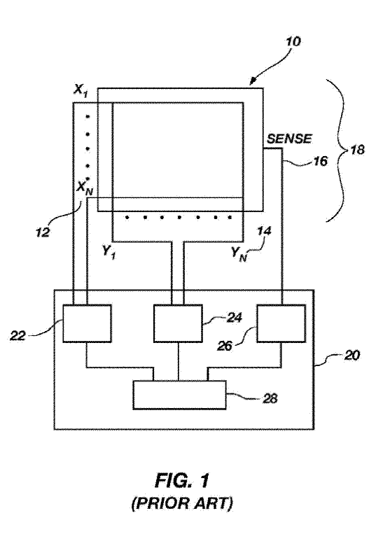

FIG. 2A is a perspective view of a physical object that will have mapped onto it a virtual object.

FIG. 2B is a perspective view of a virtual object that is mapped onto the physical object of FIG. 2A.

FIG. 3 is two views of a physical input device for a VR or AR environment of the prior art.

FIG. 4 is two views of the physical input device of FIG. 3, but with a plurality of buttons and functions mapped onto it.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It may be desirable to physically interact with Virtual Reality (VR) and Augmented Reality (AR) environments. Traditional interaction with a virtual environment has been limited to the use of a keyboard, mouse, joystick, touchpad, touchscreen or other typical computer input device while looking at a two-dimensional representation of the virtual environment on a display such as a computer display, television monitor, or a handheld device such as a smartphone. However, the new VR and AR environments may be designed to be more interactive and to include news methods of interaction.

One reason for increased interaction is that the user may be able to view the VR or AR environments in three dimensions. Accordingly, three-dimensional interaction would be a natural evolution of three-dimensional viewing. Therefore, there is a desire to enhance the user experience with three-dimensional objects in the VR or AR environments.

While it is apparent that a user may view an object in the VR or AR environments as a three-dimensional object, the user may need to have interaction. However, while a user may be able to virtually view a three-dimensional virtual object, if the user wants to make physical contact with a virtual object, options have been limited. In other words, a physical user may want to manipulate, touch, control, influence, move, or in some way interact with a three-dimensional virtual object that only exists as a construct of a VR or AR computer program. This desire for enhanced interaction may be made possible through the tactile feedback of a physical object that is mapped by the VR or AR computer program.

Tactile feedback may be obtained from a virtual object or a portion of a virtual object in the VR or AR environment by providing a corresponding physical object that the user may manipulate, touch, control, influence, move, or in some way interact with in the physical environment. The embodiments of the present invention are directed to the concept of having at least a portion of a physical object correspond to at least a portion of a virtual object in a VR or AR environment.

It should be understood that throughout this document, a physical object may represent all or just a portion of a virtual object, and that a virtual object may correspond to all or just a portion of a physical object. Thus, a physical object and a virtual object may overlap, correspond to, or be representative of each other partially or entirely.

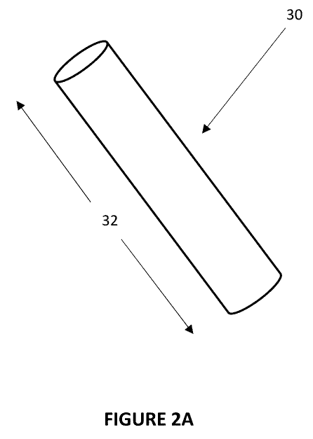

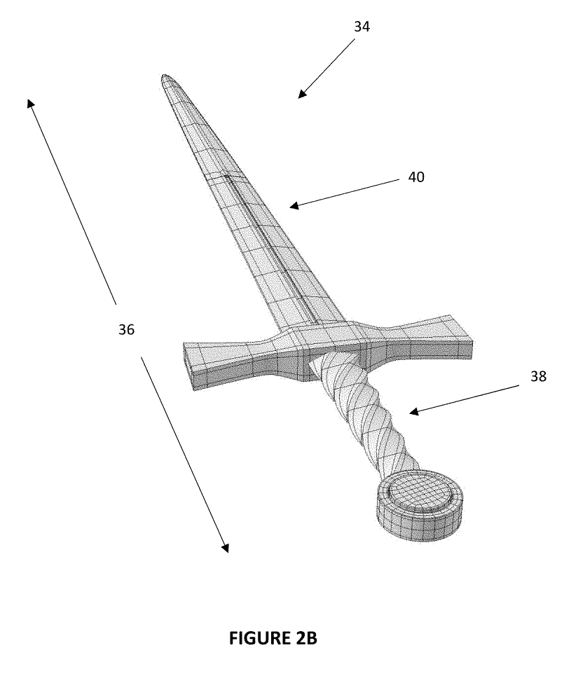

To illustrate this concept of partial or total overlap, correspondence or representation of a virtual object onto a physical object, or vice versa, it may be useful to look at a few examples. Consider a physical object shown in FIG. 2A. The physical object as shown is a cylindrical rod 30. The cylindrical rod 30 may be considered to be small enough in diameter that it may be held by a user's hand. The physical may have a handle or a feature that may be grasped by the user. The cylindrical rod 30 is shown having a length 32. The length 32 may be longer or shorter as desired. The cylindrical rod 30 is being used for illustration purposes only. Accordingly, it should be understood that the cylindrical rod 30 is only an example of any physical object that may be used in the embodiments of the invention.

FIG. 2B is an illustration of a virtual sword 34 having a length 36 and therefore is being shown as a wireframe to emphasize the virtual aspect of the virtual sword. The virtual sword 34 may only be seen in the VR or AR environment. In this example, the cylindrical rod 30 may be a physical representation of the virtual sword 34. In other words, by providing a physical object to grasp in the physical environment, the user may more easily bridge a sensory the gap between the physical environment and the VR or AR environment.

In this example, the length 32 of the cylindrical rod 30 may be assumed to be intentionally shorter than the length 36 of the sword 34, and thus only a portion of the virtual sword is being represented by or corresponds to the cylindrical rod. However, all that is needed is for the user to be able to grasp a physical object that will represent a larger virtual object such as the virtual sword 34 in the VR or AR environment.

The user may hold the cylindrical rod 30 at an end thereof which will be made to correspond to a hilt 38 of the virtual sword 34. Thus, a virtual blade 40 of the virtual sword 34 has no physical counterpart on the cylindrical rod 30. However, the virtual blade 40 may be programmed to interact with any other virtual object in the VR or AR environment. It should be understood that the length 34 of the cylindrical rod 30 may be adjusted if the physical object needs to interact with other physical objects, or to further bridge the sensory gap.

The sensory gap may refer to the disconnect between a virtual object and a physical object. For example, a user may move the shorter physical cylindrical rod 30 while looking at the virtual sword 34 in the VR or AR environment. The user may have an expectation of feeling the larger virtual sword 34 when only receiving the physical feedback of the shorter cylindrical rod 30. Thus, there is a sensory gap because the expected physical feedback may not match what the user is seeing. However, the sensory gap may be reduced by having a physical object to hold.

It should be noted that the length 32 of the cylindrical rod 30 could have been made equal to the length 36 of the virtual sword 34 in order to reduce the sensory gap. This would be useful, for example, if the user was interacting with another user and another virtual sword in the VR or AR environment, and the users wanted to be able to strike the virtual swords against each other, and to have tactile feedback of that interaction in the physical environment.

The description above has described the motivation for being able to have a physical object correspond to a virtual object in order to reduce a sensory gap. Thus, an object in the physical world may be a substitute for a virtual object and enable the user to feel more comfortable because of tactile feedback from the physical object. However, the physical object may be more than just a static object. While the embodiments of the present invention are directed to enabling a physical object to partially or entirely correspond to a virtual object, there may also be greater functionality of the physical object.

While it may be stated that a physical object may be a physical representation of a virtual object, it is necessary to provide some means for the VR or AR computer program to use in order to make motions or actions of the virtual object match the motions or actions of the physical object. Accordingly, the embodiments of the invention may include sensors that enable the computer program creating the VR or AR environment to be able to determine the location, orientation and movement of a physical object.

Using the example of the cylindrical rod 30 and the virtual sword 34, the computer program creating the VR or AR environments may need to know how the user is holding and moving the cylindrical rod 30 in order to be able to make the virtual sword 34 mimic the motions or actions of the physical object. This may include being able to position the virtual object in the corresponding position in the VR or AR environments and to then follow the movements of the cylindrical rod 30.

The embodiments of the invention may also need the ability to make a physical object represent partially or entirely a virtual object, or to make a virtual object represent partially or entirely a physical object. The embodiments of the present invention may refer to this action as mapping.

The process or act of mapping may be defined as making a physical object be representative of a virtual object when the computer program is able to track the physical object and map a virtual object to it. The mapping of a virtual object onto a physical object may be defined as having some or all of the surfaces of a virtual object correspond to some or all of the surfaces of a physical object.

It should be stated that the mapping of a virtual object onto a physical object may not have to be exact. In other words, the virtual object may not appear identical to the physical object if it is desired that the virtual object appears to have different dimensions or functions.

Consider the example of the cylindrical rod 30 and the virtual sword 34 in FIGS. 2A and 2B. The hilt 38 of the virtual sword 34 may not conform exactly to the contours of the cylindrical rod 30. But it is not necessary for the contours to be exactly the same. The user is not looking at the physical user hand or the physical cylindrical rod 30, but only a representation of the hand and the virtual sword 34 in the VR or AR environment. Furthermore, the virtual sword 34 may be much larger and appear to have a flattened virtual blade 40 as shown in FIG. 2B, while the cylindrical rod 30 does not have these features in FIG. 2A.

It may be considered an aspect of the embodiments of the invention that the virtual object that is mapped to the physical object may have more or less material than the physical object. It is another aspect of the embodiments that the virtual object may be endowed with many features and functions that are not present on the physical object. These features may include, but should not be considered to be limited to, controls, buttons, triggers, attachments, peripheral devices, touch sensitive surfaces, handles, surfaces, or any other embellishment, surface or feature that is needed to create the desired virtual object in the virtual environment. It should be understood that the virtual objects that may be created may only exist in a virtual environment, and not in physical reality.

One way that the features of the virtual object may be different from the physical object is that that virtual object may appear to include many more functions, physical features or embellishments. This is typical of a virtual object that is being used in an environment such as a game or simulation. For example, the physical object may be a simple pistol-type grip which may be mapped to a very large and elaborate piece of equipment in the VR or AR environment.

Therefore, it should be understood that the VR or AR environment may map a much more elaborate virtual object with smaller, larger or different dimensions onto a smaller, larger or differently shaped physical object. What is important is that at least a portion of a virtual object is able to be mapped onto a physical object in such a way that the user may manipulate, touch, control, influence, move, or in some way interact with the virtual object while manipulating, touching, controlling, influencing, moving, or in some way interacting with the physical object that represents at least a portion of the virtual object.

The success of mapping a virtual object onto a physical object may depend on the sensors that are available to the VR or AR computer program that is used to track the physical object and create the VR or AR environment. However, the actual sensors that are being used may be selected from the group of sensors comprised of capacitive, pressure, optical, thermal, conductive, ultrasonic, piezoelectric, etc. These sensors are well known to the prior art. However, it is the application of the sensors to the embodiments of the invention that is novel. Accordingly, any sensor that is capable of determining the orientation, movement and location of the physical object and how contact is made by the user with the physical object, may be considered to be within the scope of the embodiments of the invention.

It should be understood that there are two types of sensors that may be part of the embodiments of the invention. The first type of sensor is internal or external but part of the physical object and enables the VR or AR computer program to know the position and orientation of the physical object. Once the position and orientation are known, all or a portion of the physical object may be created within the VR or AR environment as a portion or all of a virtual object, and the virtual object may be mapped to the physical object.

For example, if the physical object is the cylindrical rod 30, then the sensors are used to determine the location, movement and orientation of the cylindrical rod. The sensors that are used to determine the location, movement and orientation may be disposed internally to the physical object such as inside the cylindrical rod 30, they may be disposed external to the physical object but on the surface thereof, or they may be a combination of internal and external sensors.

In all of the embodiments of the invention, the physical object may also be referred to as an “input device” which will be used hereinafter to refer to the physical object. Therefore, the cylindrical rod 30 may be an input device to the VR or AR computer program.

The second type of sensor is not part of the input device itself but is some sensor that is used by the VR or AR computer program that is creating the VR or AR environment.

It should also be understood that in all of the embodiments of the invention, more than one type of virtual object may be mapped to the physical object. That is why the mapping may be referred to as arbitrary. Thus, the input device may assume the attributes of any number of virtual objects. If the virtual object may be programmed as part of the computer program creating the VR or AR environments, then the virtual object may also be mapped to the input device.

Thus, the cylindrical rod 30 may be the hilt 38 of a virtual sword 34, a handle for a bag, a grip of a pistol-like weapon or any other object that can be held in the user's hand. The arbitrary nature of the mapping thus refers to the endless variety of virtual objects that may be mapped to the input device.

Furthermore, it should be understood that the mapping of the virtual object onto the input device may be changed at any time. Thus, while the user is holding the input device, the virtual object that is mapped on to it may be completely changed. For example, the input device may be a weapon, and then the mapping may be changed so that the input device is a different weapon, or not a weapon at all. For example, the weapon may be transformed into a tool. Thus, the input device may become a keyboard, a keypad or a touchpad or any of the other virtual objects that are desired.

It should be understood that the embodiments of the invention enable the dimensions of the physical object to be programmed into the VR or AR computer program, or the dimensions may not be programmed, and the computer program may rely on internal, external, or both types of sensors on the input device, or sensors that are not part of the input device but are used by the VR or AR computer program to enable it determine the dimensions, and then perform the mapping of the virtual object onto the input device.

One aspect of the embodiments of the present invention is that the sensors that may be internal or external to the input device may be capacitive, pressure, optical, thermal, conductive, ultrasonic, piezo-electric, etc.

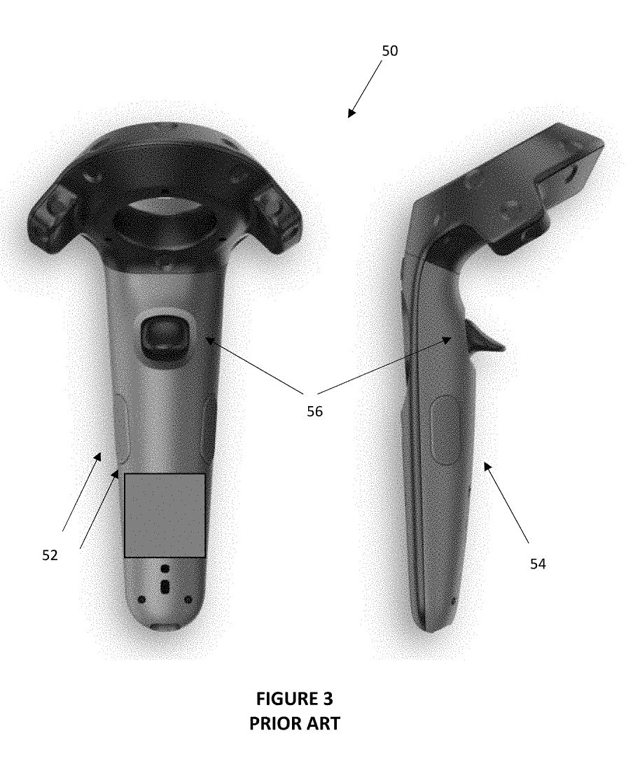

FIG. 3 is provided as an example of a prior art input device that is being used as an input device 50 in a VR or AR environment. FIG. 3 shows a bottom view 52 and a profile view 54 of the handheld input device 50. The input device 50 includes a trigger 56 that is seen in both views.

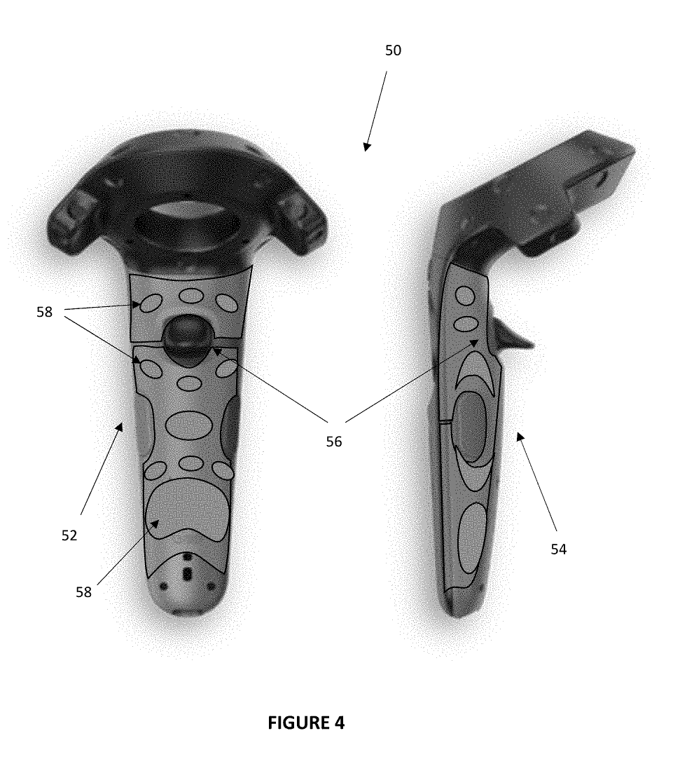

In contrast, FIG. 4 shows the same bottom view 52 and profile view 54 of the input device 50. What is changed is that a portion of the input device 50 has been mapped with a plurality of virtual buttons and functions 58. These buttons and functions 58 may only be seen in the VR or AR environment, and may be disposed anywhere on the input device 50.

Accordingly, the input device which may have had only a few buttons or functions before may now be loaded with many buttons and functions. While these buttons and functions 58 may only appear when viewed in the VR or AR environment, that is the only place that they are needed. It should also be understood that these buttons and functions may be anything that can be programmed into the VR or AR computer program.

Now, while FIG. 4 is showing the virtual buttons and functions 58 on the input device 50, it is another aspect of the invention that a plurality of sensors may be added to the physical input device so that the VR or AR computer program may be able to determine when the virtual buttons or functions are being used. Thus, the input device 50 may or may not have sensors to assist the VR or AR computer program to determine when buttons or functions on the virtual object are being used.

Another aspect of the embodiments of the invention is that the sensors that are part of the input device 50 may not require touch. The sensors may be capable of proximity sensing as well as touch sensing.

The example of FIGS. 3 and 4 shows that an existing game controller input device may be mapped to become a virtual object in the VR or AR environment. However, the input device may also be any existing game controller or any new game controller that may be created.

Another aspect of the embodiments of the invention is that the physical object that is the input device could be an inert object with no sensors of its own, or it could be a game controller with a plurality of built-in sensors. For example, the input device could be a block of wood with a handle carved into it. However, when this block of wood is viewed within the VR or AR environment, and a virtual object is mapped to it, then the user may see an input device that has numerous controls and buttons, and any other number of interactive devices on it.

In contrast, the input device may also be an actual game controller having real buttons, joysticks, sensors, touchpads, keypads, keyboards or touchscreens. The user is not able to see the physical input device in the VR or AR environment. But the VR or AR computer program may now enable the input device to be see a virtual representation of all of the buttons, joysticks, sensors, touchpads, keypads, keyboards or touchscreens. Thus, mapping may be on an insert physical object or an actual functioning input device with sensors. The VR or AR environment can then make the input device appear as desired.

One aspect of the embodiments is to map the surface of an input device such as a game controller so that the game controller can provide useful feedback to the VR or AR computer program from the actual controls in the game controller. Thus, the game controller may have buttons for input. These buttons may correspond to various functions of an elaborate weapon. If the VR or AR compute program is able to sense precise user interaction with the game controller, then the virtual object may be manipulated to function as whatever virtual object is being mapped to the game controller.

Some examples of mapping of a virtual object may include such things as remapping the surface of an input device to be a keyboard or keypad. By precise mapping of the virtual object onto the input device, the VR or AR computer program enables typing on the input device.

Another example is mapping the input device to be an object that is dirty and covered in virtual dirt or mud. The user then wipes the surfaces of the input device and the virtual dirt or mud is removed as the input device is cleaned.

Another example is mapping the input device to function as a tablet and thereby include a virtual touchscreen.

It should be understood that there may be a distinction between mapping and visual mapping. The act of mapping may be defined as applying functions of a virtual device onto a physical object. In contrast, visual mapping may be defined as making changes to a virtual device visible to the user. Accordingly, not all changes to the function of a virtual device may be displayed within the VR or AR environment. However, visual mapping may provide substantial and useful clues to the user how the functions of a virtual device may have changed.

For example, both the virtual device and the physical input device may be equipped with displays, and the displays may show different controls and input areas on the displays.

It was explained previously that tactile feedback may be provided to the user because a physical input device may be used in conjunction with a corresponding virtual device. However, it should be understood that tactile feedback may not be limited to the physical input device simply being present. The physical input device may also incorporate haptics in order to provide additional tactile feedback. Haptic motors may be used in many different forms and all manner of haptic engines should be considered to be within the scope of the embodiments of the invention.

It should be understood that the principles of the embodiments of the invention may be adapted and applied to physical objects that are not being held by a user. Accordingly, a virtual object may be mapped to a physical object that is adjacent to the user and which the user may interact with even if the object is not held by or being worn by the user.

It should also be understood that the user may not have to view the AR or VR environment using AR or VR goggles that provide a three-dimensional view of the VR or AR environment. The user may also be using a display that shows the VR or AR environment on a two-dimensional display.

In summary, the embodiments of the invention may be directed to a system for providing a virtual object in a virtual reality (VR) or augmented reality (AR) environment that is mapped to a physical object. This may be possible by first providing a VR or AR computer program that is running on a computing device and creating a VR or AR environment, wherein the VR or AR environment may be viewed by a user. A physical object that may be held by a user may also be required. A virtual object is also provided that exists in the VR or AR computer program and which may be seen by the user when viewing the VR or AR environment. The virtual object may include controls, buttons, triggers, attachments, peripheral devices, touch sensitive surfaces, handles, surfaces, or any other embellishment, surface or feature that do not exist on the physical object.

The next step is mapping the virtual object to the physical object to thereby bridge a sensory gap between a physical environment and the VR or AR environment, wherein the user is able to hold the physical object while simultaneously viewing the virtual object that is mapped to the physical object.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A system for providing a virtual object in a virtual reality (VR) or augmented reality (AR) environment that is mapped to a physical object, said system comprised of:
a VR or AR computer program that is running on a computing device and creating a VR or AR environment, and wherein the VR or AR environment may be viewed by a user;
a physical object that may be held by a user;
a virtual object that exists in the VR or AR computer program and which may be seen by the user when viewing the VR or AR environment, and wherein the virtual object includes controls, buttons or features that do not exist on the physical object; and
mapping the virtual object to the physical object to thereby bridge a sensory gap between a physical environment and the VR or AR environment, wherein the user is able to hold the physical object while simultaneously viewing the virtual object that is mapped to the physical object.

2. The system as defined in claim 1 wherein the system is further comprised of the physical object being smaller than the virtual object but at least overlapping at a location where the user may hold the physical object in the physical environment and hold the virtual object in the virtual environment.

3. The system as defined in claim 1 wherein the system is further comprised of the physical object having the same dimensions as the virtual object.
